(19) United States
(12) Patent Application Publication
(10) Pub. No.: US 2008/0070000 A1
(43) Pub. Date: Mar. 20, 2008

(54) Circuit module with interposer and method for manufacturing the same

(75) Inventor: Jin Suzuki, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/888,543

(22) Filed: Jul. 31, 2007

(30) Foreign Application Priority Data
Sep. 20, 2006 (JP) 2006-254264

(51) Int. Cl. B32B 3/10; H01R 43/00

(52) U.S. Cl. 428/138; 29/593; 29/829

(57) ABSTRACT

A circuit module includes a multilayer wiring board having a cavity portion and an interposer on which a chip part is mounted. The interposer is bonded to the multilayer wiring board so that the chip part is disposed in the cavity portion and the cavity portion is hermetically sealed. In the manufacturing process for the circuit module, a continuity test of the chip part is conducted by applying a testing voltage to the interposer before the interposer is bonded to the multilayer wiring board.

### CLAIM OF PRIORITY

This application claims benefit of the Japanese Patent Application No. 2006-254264 filed on Sep. 20, 2006, which is hereby incorporated by reference.

### BACKGROUND OF THE INVENTION

1. Field of the Invention

The present invention relates to a circuit module and a manufacturing method thereof, and more particularly to a circuit module to be preferably used for a circuit including a chip type piezoelectric element and a manufacturing method thereof.

2. Description of the Related Art

A circuit module such as a hybrid module and the like is generally formed in such a way that a chip type circuit element such as a condenser, inductor, filter, resonator, delay element, or the like is bonded to a multilayer wiring board so as to be electrically connected.

A piezoelectric element used as the above filter, resonator, delay element, or the like sensitively responds to a change in environment such as temperature, humidity, and the like, so the environment around the piezoelectric element should be maintained to be constant. For that reason, in the case of a known circuit module 101 shown in FIG. 4, the environment around a piezoelectric element 103 is maintained to be constant by disposing the piezoelectric element 103 in a cavity portion 102a that is formed to be recessed in a multilayer wiring board 102 and is sealed by using a metal lid 107 or a sealing resin (not shown), as is disclosed in Japanese Unexamined Patent Application Publication No. 2000-58741.

In addition, since the piezoelectric element 103 to be mounted is a small chip part, it is difficult to conduct a continuity test of the piezoelectric element 103 before mounting it onto the multilayer wiring board 102. Therefore, the continuity test is generally conducted after the piezoelectric element 103 has been mounted onto the multilayer wiring board 102.

### SUMMARY OF THE INVENTION

There has been a problem, however, that when a continuity test of a circuit module 101 in which a piezoelectric element 103 is mounted reveals the piezoelectric element 103 to be defective, the whole circuit module 101 has to be discarded because of the enclosed piezoelectric element 103. In the case when other semiconductor chip parts 11, 12, 13 and 14 are mounted in the circuit module 101 that has to be discarded, since it is not possible to remove the semiconductor chip parts 11, 12, 13 and 14 for reuse after mounting, the semiconductor chip parts 11, 12, 13 and 14 that normally function also have to be discarded at the same time, which is uneconomical.

Furthermore, in the case of the conventional circuit module 101, the piezoelectric element 103 has to be mounted in the cavity portion 102a; however, it is very difficult to bond the piezoelectric element 103 onto the multilayer wiring board 102 in the place, which would bring about a problem that the circuit module 101 fails in operation due to bonding failure. Such the circuit module 101 failed in operation due to bonding failure cannot be reused, and the whole circuit module 101 has to be discarded as the same as the above case.

The present invention addresses the above problems by providing a circuit module that enables to reduce the occurrence of errors in operation due to bonding failure, as well as to reduce the amount of losses caused by mounting a defective chip part.

The present invention also provides a manufacturing method of a circuit module that can prevent the circuit module causing malfunctions due to bonding failure or mounting a defective chip part from being manufactured.

On that account, as the first aspect, a circuit module according to the present invention includes a multilayer wiring board having a cavity portion and an interposer onto which a chip part is mounted, the interposer being bonded onto the multilayer wiring board so that the chip part is disposed in the cavity portion and electrically connected to the multilayer wiring board.

According to the circuit module of the first aspect, it becomes possible to reduce the unit cost of a wiring board for mounting the chip part by using the interposer onto which the chip part is mounted. Moreover, the bondability of the chip part can be facilitated by mounting the chip part onto the interposer, compared to mounting the chip part directly onto the cavity portion.

A circuit module of the second aspect according to the present invention is characterized in that the chip part of the circuit module of the first aspect is connected to the interposer by flip-chip bonding.

According to the circuit module of the second aspect, the interposer onto which the chip part is mounted can be reduced in thickness, which is conducive to slimming down of the circuit module. Moreover, because the flip-chip bonding is apt to have a higher risk of bonding failure compared to wire bonding, an effect that the amount of losses due to discarding defective parts is reduced can be effectively obtained by using the interposer.

A circuit module of the third aspect according to the present invention is characterized in that the interposer of the circuit module of the first and second aspects has a multilayer structure.

According to the circuit module of the third aspect, since the mechanical strength of the interposer is increased, it becomes possible to reduce external forces acting on the chip part caused by distortion of the interposer.

A circuit module of the fourth aspect according to the present invention is characterized in that the chip part of the circuit module of the first to third aspects is a piezoelectric element and the interposer is bonded so that the cavity portion is hermetically sealed.

According to the circuit module of the fourth aspect, it becomes possible to prevent the properties of the piezoelectric element, which is the chip part, from being changed in response to a change in humidity by hermetically sealing the cavity portion of the multilayer wiring board.

A circuit module of the fifth aspect according to the present invention is characterized in that the multilayer wiring board and the interposer of the circuit module of the fourth aspect are eutectically bonded by using frame-like eutectic bonding metal films provided respectively in the peripheral area of the cavity portion and in the peripheral area of the surface of the interposer facing the multilayer wiring board, and electrically connected to each other through through-holes formed inside or outside the frame of the respective eutectic bonding metal films.

According to the circuit module of the fifth aspect, a frame-like eutectic bonding layer, which provides superior bonding reliability and sealing ability, can be formed by eutectically bonding the interposer and the multilayer wiring board together.

A manufacturing method of a circuit module according to the present invention is characterized in comprising a first process for mounting a chip part onto an interposer, a second process for conducting a continuity test of the chip part by applying a testing voltage to the interposer, and a third process for hermetically sealing a cavity portion formed to be recessed in a multilayer wiring board by using the interposer onto which the chip part that passed the continuity test is mounted so that the chip part is disposed in the cavity portion, and for electrically connecting the interposer to the multilayer wiring board.

According to the manufacturing method of the circuit module of the present invention, it is possible to conduct the continuity test of the chip part before electrically connecting the chip part to the multilayer wiring board, and then to connect the interposer, onto which the chip part is mounted, to the multilayer wiring board after the chip part is confirmed not to be defective. Moreover, since bonding the chip part onto the interposer and also bonding the interposer onto the multilayer wiring board are easily performed compared to directly bonding the chip part onto the multilayer wiring board, the bonding process for the circuit module can be facilitated.

The circuit module according to the present invention produces an effect that the amount of loss caused by mounting defective chip parts can be reduced since the unit cost of a wiring board onto which the chip part is mounted is reduced. In addition, the circuit module according to the present invention produces another effect that operational errors of the circuit module due to bonding failure can be reduced since the bonding between the chip part and the multilayer wiring board is facilitated by using the interposer.

The manufacturing method of the circuit module according to the present invention enables the interposer onto which the chip part is mounted to be bonded to the multilayer wiring board after the chip part is confirmed not to be defective, and also that the bonding process for the circuit module is facilitated. For these reasons, an effect is produced that manufacturing of defective circuit modules, which bring operational errors due to mounting of a defective chip part or bonding failure, can be avoided.

### BRIEF DESCRIPTION OF THE DRAWINGS

FIG. 1 is a vertical cross-sectional view of a circuit module according to an embodiment of the present invention;

FIG. 2 is a perspective view of a multilayer wiring board according to the embodiment;

FIGS. 3A to 3C are vertical cross-sectional views of the circuit module according to the embodiment in the order of manufacturing steps; and

FIG. 4 is a vertical cross-sectional view of a known circuit module.

### DESCRIPTION OF THE PREFERRED EMBODIMENTS

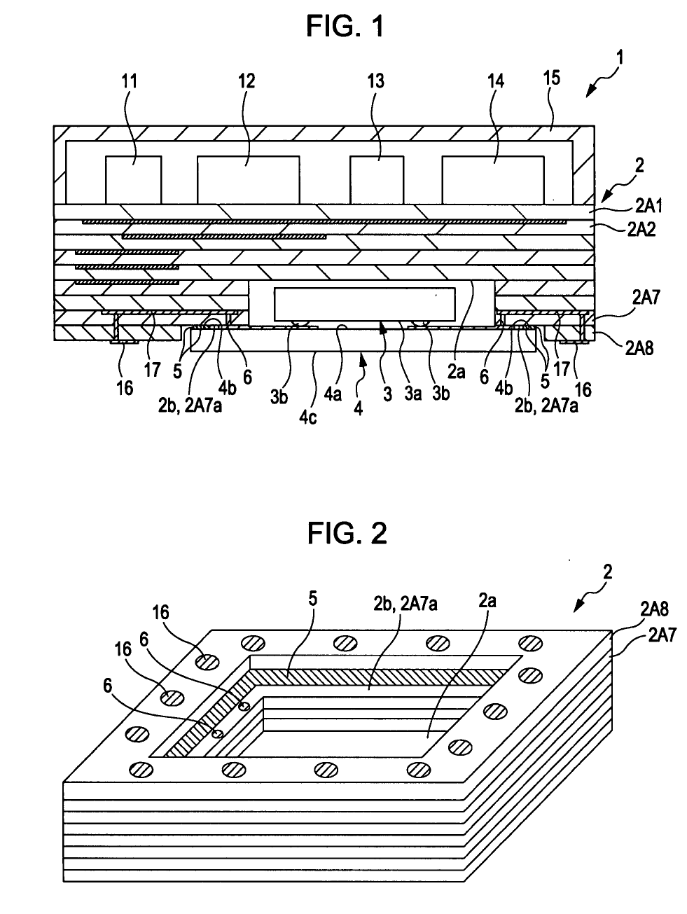

A circuit module of the present invention will be described below with reference to an embodiment using FIGS. 1 and 2. FIG. 1 is a vertical cross-sectional view of the circuit module according to this embodiment, and FIG. 2 is a perspective view of a multilayer wiring board according to this embodiment.

The circuit module 1 according to this embodiment includes a multilayer wiring board 2, a chip part 3, and an interposer 4 as shown in FIG. 1.

The multilayer wiring board 2 according to this embodiment is formed by laminating eight layers of wiring boards from the first layer (top layer) 2A1 to the eighth layer (bottom layer) 2A8; wherein the eight wiring board layers 2A1 to 2A8 are electrically connected to each other through through-holes (not shown). The multilayer wiring board 2 is provided with a plurality of chip parts 11, 12, 13 and 14 such as a condenser, inductor, filter circuit and the like on the top face of the first layer 2A1, the chip parts being covered with a cover 15, and also provided with flat electrodes 16 for external input and output signals on the surface of the eighth layer 2A8.

As shown in FIGS. 1 and 2, a cavity portion 2a is formed in the lower face of the multilayer wiring board 2 so as to have a depth equivalent to the thickness of four layers of the multilayer wiring board 2; the interior space of the cavity portion 2a is commensurate with the size of the chip part 3 disposed therein. The circuit module 1 according to this embodiment is configured so that the eighth layer 2A8, which is the most external layer among wiring board layers forming the cavity portion 2a, has an opening area larger than that of the seventh layer 2A7 underneath the eighth layer 2A8, through which a bonding area 2A7a for bonding the interposer 4 onto the surface of the seventh layer 2A7 is furnished in the peripheral area 2b of the cavity portion 2a. On the bonding area 2A7a, there is disposed a frame-like eutectic bonding metal film 5, which is composed of a eutectic material such as Au—Sn eutectic material, Au—Ag eutectic material, or the like.

The chip part 3 is mounted on the interposer 4 as shown in FIG. 1, and disposed inside the cavity portion 2a. As the chip part 3 according to this embodiment, a piezoelectric element such as a SAW (Surface Acoustic Wave) filter, BAW (Bulk Acoustic Wave) filter, and the like is used. The chip part 3 has bumps 3b on its surface facing the interposer 4 and is connected to the interposer 4 by flip-chip bonding.

The interposer 4, having a multilayer structure in this embodiment, is an interconnecting wiring board for electrically interconnecting the chip part 3 and the multilayer wiring board 2. The interposer 4 is bonded onto the bonding area 2A7a of the cavity portion 2a so that the chip part 3 is disposed inside the cavity portion 2a. More specifically, the interposer 4 according to this embodiment is provided with the frame-like eutectic bonding metal film 5 in the peripheral area 4b of its surface 4a facing the multilayer wiring board 2, and eutectically bonded to the multilayer wiring board 2 so that the cavity portion 2a is hermetically sealed. At that time, it is desirable to make the inside of the cavity portion 2a to be a nitrogen atmosphere to maintain a constant environment for the chip part 3 enclosed therein. The interposer 4 is electrically connected with wiring patterns 17 disposed inside the multilayer wiring board 2 and with the flat electrodes 16 disposed on the eighth layer 2A8, as shown in FIGS. 1 and 2, through through-holes 6 which are formed inside the frame of the eutectic bonding metal film 5.

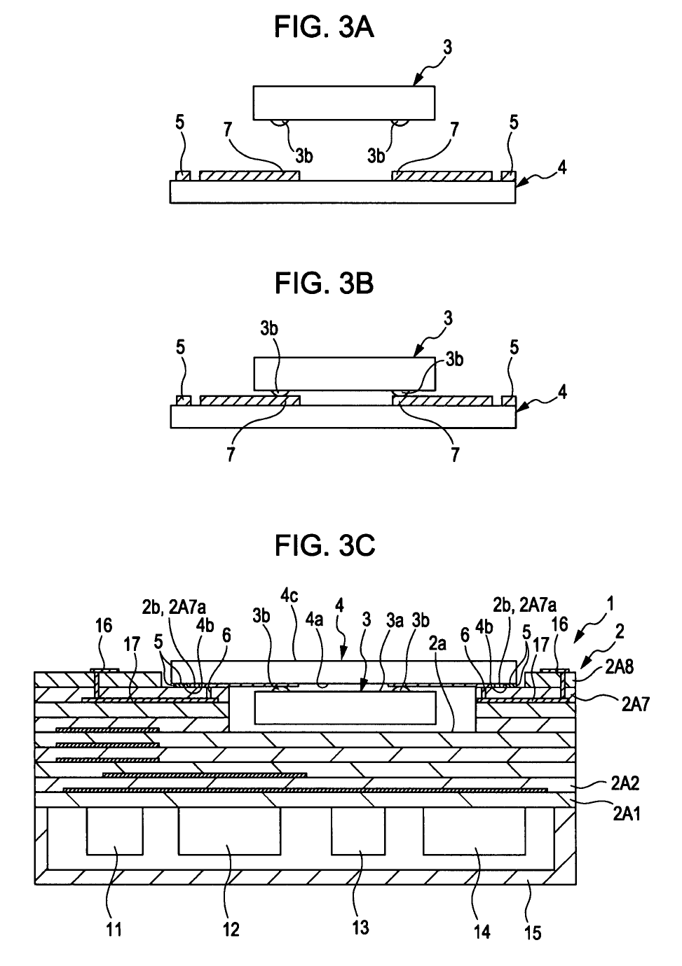

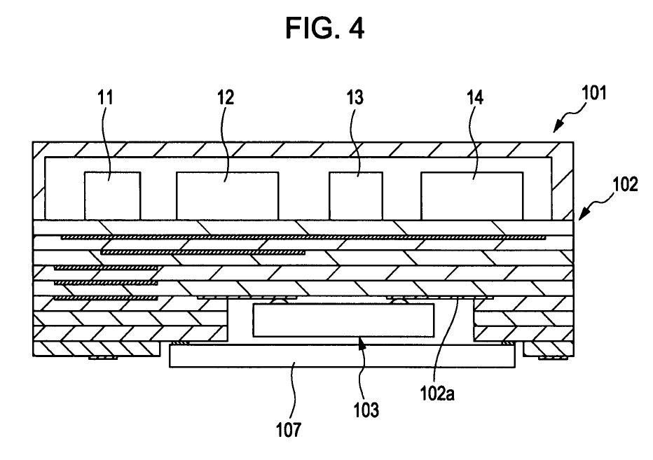

Next, a manufacturing method for the above circuit module 1 will be described with reference to FIGS. 3A to 3C; wherein the manufacturing method of the circuit module according to this embodiment is shown in the order of FIGS. 3A, 3B and 3C. This circuit module 1 is manufactured by performing a first process through a third process.

In the first process, as shown in FIGS. 3A and 3B, a chip part 3 is mounted on an interposer 4. It is possible to employ a common electrical connection method such as soldering, eutectic bonding, or the like for bonding bumps 3b of the chip part 3 and connection terminals 7 of the interposer 4. As described above, the chip part 3 according to this embodiment is connected to the interposer 4 by a flip-chip bonding method.

In the second process, a continuity test of the chip part 3 is conducted by applying a testing voltage to the interposer 4 shown in FIG. 3B. It is preferable to conduct the continuity test in the same environment as that in the cavity portion 2a (see FIG. 1) in which the chip part 3 will be enclosed; that is, when the atmosphere in the cavity portion 2a is a nitrogen atmosphere, it is preferable to conduct the continuity test of the chip part 3 in a nitrogen atmosphere. After having passed the continuity test, the chip parts undergo the third process. When not passed, the interposer 4 on which a defective chip part 3 is mounted is discarded, and a new chip part 3 mounted on a new interposer 4 undergoes the continuity test.

In the third process, the interposer 4 on which the chip part 3 that passed the continuity test is mounted is bonded to a multilayer wiring board 2 as shown in FIG. 3C. At that time, the interposer 4 should be positioned so that the chip part 3 mounted on the interposer 4 is disposed inside the cavity portion 2a formed in the multilayer wiring board 2; thereafter, the interposer 4 is bonded to the multilayer wiring board 2.

In the third process according to this embodiment, using frame-like eutectic bonding metal films 5 previously disposed in the peripheral area 4b of the interposer 4 and the peripheral area 2b of the cavity portion 2a respectively, after being positioned, the interposer 4 is eutectically bonded to the multilayer wiring board 2 so that the cavity portion 2a containing the chip part 3 is hermetically sealed. Before the interposer 4 is eutectically bonded to the multilayer wiring board 2, through-holes 6 through which the interposer 4 and the multilayer wiring board 2 are electrically connected are formed inside the frame-like eutectic bonding layer formed by eutectic bonding.

It is noted that the electrical connection between the interposer 4 and the multilayer wiring board 2 is not necessarily achieved with the through-holes 6, but may be achieved by soldering or eutectically bonding connection terminals (not shown) of the interposer 4 and the multilayer wiring board 2 together, the connection terminals being formed inside the respective eutectic bonding layers.

Now, effects offered by a circuit module 1 according to this embodiment will be described with reference to FIGS. 1 and 3A to 3C.

In the circuit module 1 according to this embodiment, an interposer 4 is used for electrically connecting a chip part 3 to a multilayer wiring board 2, i.e., mounting of the chip part 3 to the interposer 4 enables the unit cost of a wiring board on which the chip part 3 is directly mounted to be reduced, the wiring board meaning the interposer 4 in this embodiment.

Even if the manufacturing yield of the chip parts 3 could be improved, it is not possible to completely eliminate occurrence of defective parts. Furthermore, the chip part 3 is so small that it is very difficult to conduct a continuity test for each part independently. That is to say, in the case that the continuity test would reveal the chip part 3 to be defective, the amount of loss due to discarding the defective parts can be lowered by reducing the unit cost of the wiring board on which the chip part 3 is mounted. Additionally, the mass of discarded parts is less than before, which would be conducive to the environment.

The bondability of the chip part 3 can be enhanced by being mounted on the interposer 4, where bonding of the chip part 3 can be easily performed, compared to being mounted directly to a recessed small cavity portion 2a, in which bonding of the chip part 3 is not easily performed. Furthermore, it is possible to reduce the risk of bonding failure between the interposer 4 and the multilayer wiring board 2 to almost zero, since each bonding face of the interposer 4 and the multilayer wiring board 2 is freely expandable at the designing stage. That is, since the bondability of the chip part 3 can be enhanced by mounting the chip part 3 onto the interposer 4 and then bonding the interposer 4 to the multilayer wiring board 2 compared to mounting the chip part 3 directly onto a recessed cavity portion 2a, it becomes possible to prevent the circuit module 1 from operationally failing due to bonding failure.

The chip part 3 is bonded on the interposer 4 by a flip-chip bonding method. The interposer 4 on which the chip part 3 is mounted by flip-chip bonding can be reduced in thickness, which is conducive to slimming down of the circuit module 1. The flip-chip bonding method, however, is apt to have a higher risk of bonding failure compared to a wire bonding method. Regarding this point, it is meaningful to mount the chip part 3 on the interposer 4 because the risk of bonding failure caused by flip-chip bonding can be reduced due to facilitated bondability of the chip part 3. Namely, the advantages of using the interposer 4 are offered by utilizing the flip-chip bonding method.

In addition, since the chip part 3 is disposed inside the cavity portion 2a, the chip part 3 being damaged or suffering a malfunction due to external forces can be avoided. This effect can be obtained even though the cavity portion 2a is not hermetically sealed.

In the circuit module 1 according to this embodiment, the interposer 4 has a multilayer structure for the reason that damage or malfunction of the chip part 3 can be avoided. The interposer 4 having a multilayer structure is increased in mechanical strength such as bending stiffness, torsion stiffness, and the like; therefore it becomes possible to reduce external forces acting on the chip part 3 caused by distortion of the interposer 4. Additionally, the interposer 4 having a multilayer structure allows a complex wiring pattern to be formed, which enables another chip part 3 to be mounted on the underside 4c of the interposer 4, shown in FIG. 1, on which the chip part 3 is bonded.

In the circuit module 1 according to this embodiment, a piezoelectric element such as a SAW filter, BAW filter, or the like is mounted on the interposer 4 as the chip part 3, so the interposer 4 is bonded so that the cavity portion 2a is hermetically sealed. Although the piezoelectric element easily changes its properties in response to a change in environment, particularly to a change in humidity, it becomes possible to prevent the properties of the chip part 3, that is a piezoelectric element, from being changed in response to a change in humidity by hermetically sealing the cavity portion 2a of the multilayer wiring board 2. Furthermore, since the inside of the cavity portion 2a contains a nitrogen atmosphere in this embodiment, an adverse effect due to a change in humidity can be minimized.

Among various bonding methods applicable to bonding between the multilayer wiring board 2 and the interposer 4, a eutectic bonding method is chosen for bonding between the multilayer wiring board 2 and the interposer 4 in the circuit module 1 according to this embodiment. The eutectic bonding is carried out by using frame-like eutectic bonding metal films 5 respectively disposed in the peripheral area 2b of the cavity portion 2a (bonding area 2A7a of the seventh layer 2A7 of the multilayer wiring board 2 in this embodiment) and the peripheral area 4b of the surface 4a of the interposer 4 facing the multilayer wiring board 2. As a consequence, a frame-like eutectic bonding layer can be formed between the interposer 4 and the multilayer wiring board 2, by which high bonding reliability is obtained and hermetical sealing of the cavity portion 2a is secured.

The above circuit module 1 according to this embodiment is manufactured by performing the first process through the third process as shown in FIGS. 3A to 3C. In the second process, as shown in FIGS. 3A and 3B, a continuity test is applied to the chip part 3 that has been mounted on the interposer 4 in the first process.

In known methods, since no interposer is used between a chip part and a multilayer wiring board, a continuity test for the chip part cannot be conducted until the chip part is mounted to the multilayer wiring board, whereas it is possible to judge whether the chip part 3 is passed or failed before the chip part 3 is electrically connected to the multilayer wiring board 2, since the chip part 3 is mounted on the interposer 4 in this embodiment. That is, the chip part 3 can be checked through a continuity test before being electrically connected to the multilayer wiring board 2, and after the chip part 3 is confirmed not to be defective, the interposer 4 on which the chip part 3 is mounted can be bonded to the multilayer wiring board 2. As a consequence, the circuit module 1 having to be discarded due to a defective chip part 3 can be avoided.

In the third process, the interposer 4 on which the chip part 3 that passed the continuity test is mounted is bonded to the multilayer wiring board 2 so that the cavity portion 2a is hermetically sealed. As described above, since bonding the chip part 3 to the interposer 4 and also bonding the interposer 4 to the multilayer wiring board 2 are easily performed compared to directly bonding the chip part 3 to the multilayer wiring board 2, the bonding process for the circuit module 1 can be facilitated. Therefore, the circuit module 1 having to be discarded due to bonding failure of the chip part 3 or the interposer 4 is avoided.

That is to say, the circuit module 1 according to this embodiment produces an effect that the amount of loss caused by mounting defective chip parts 3 can be reduced since the unit cost of a wiring board on which the chip part 3 is mounted is reduced. In addition, the circuit module 1 according to this embodiment produces another effect that operational errors of the circuit module 1 due to bonding failure can be reduced since the bonding between the chip parts 3 and the multilayer wiring board 2 is facilitated by involving the interposer 4.

The manufacturing method of the circuit module 1 according to this embodiment enables the interposer 4 onto which the chip part 3 is mounted to be bonded to the multilayer wiring board 2 after the chip part is confirmed not to be defective, and also that the bonding process for the circuit module 1 is facilitated. For these reasons, an effect is produced that manufacturing of the circuit module 1 which brings operational errors due to mounting of a defective chip part 3 or bonding failure can be avoided.

It is noted that the application of the present invention is not limited to the embodiment described above, but can be modified in various ways as necessary.

For example, although the through-holes 6 for connecting the interposer 4 to the multilayer wiring board 2 are formed inside the frame of the eutectic bonding metal film 5 as shown in FIG. 2 in this embodiment, the through-holes 6 may be formed outside the frame of the eutectic bonding metal film 5 in another embodiment. In that case, it is desirable that the wiring pattern for connecting the through-holes 6 to the chip part 3 is provided to the face other than the face on which the eutectic bonding metal film 5 is formed in order to prevent the risk of a short-circuit caused by contact between the through-holes 6 and the eutectic bonding metal film 5.

What is claimed is:

1. A circuit module with an interposer comprising:
a multilayer wiring board having a cavity portion; and
an interposer on which a chip part is mounted,
wherein the interposer is bonded to the multilayer wiring board so that the chip part is disposed in the cavity portion and electrically connected to the multilayer wiring board.

2. The circuit module with an interposer according to claim 1,
wherein the chip part is connected to the interposer by flip-chip bonding.

3. The circuit module with an interposer according to claim 1,
wherein the interposer has a multilayer structure.

4. The circuit module with an interposer according to claim 1,
wherein the chip part is a piezoelectric element, and the interposer is bonded so as to hermetically seal the cavity portion.

5. The circuit module with an interposer according to claim 4,
wherein the multilayer wiring board and the interposer are eutectically bonded by using frame-like eutectic bonding metal films respectively formed in the peripheral area of the cavity portion and in the peripheral area of a surface of the interposer, the surface facing the multilayer wiring board, and also electrically connected to each other through through-holes formed inside or outside the frame of the respective eutectic bonding metal films.

6. A manufacturing method of a circuit module with an interposer comprising:
a first process for mounting a chip part on an interposer;
a second process for conducting a continuity test of the chip part by applying a testing voltage to the interposer; and
a third process for hermetically sealing a cavity portion formed to be recessed in a multilayer wiring board by using the interposer, on which the chip part that passed the continuity test is mounted, so that the chip part is disposed in the cavity portion, and for electrically connecting the interposer to the multilayer wiring board.
